(19) United States
(12) Patent Application Publication
(10) Pub. No.: US 2013/0112091 A1
(43) Pub. Date: May 9, 2013

(54) POT WITH DIVIDER SYSTEM

(71) Applicant: AnnaMaria Page, Cedar Knolls, NJ (US)

(72) Inventor: AnnaMaria Page, Cedar Knolls, NJ (US)

(21) Appl. No.: 13/292,779

(22) Filed: Nov. 9, 2011

(51) Int. Cl. A47J 37/00

(52) U.S. Cl. 99/448

(57) ABSTRACT

The present invention provides a single pot with a divider system incorporated therein to allow for removably attachable divider to be inserted into the pot to create compartments therein. The divider system includes channels in the pot's surfaces and a seal element therein to mate with the dividers and prevent fluid communication between the compartments within the pot.

### CROSS-REFERENCE TO RELATED APPLICATION

This application claims priority to U.S. Provisional Patent Application No. 61/279,777 filed on Nov. 12, 2010, all of which are incorporated herein by reference.

### FIELD OF THE INVENTION

The present invention relates generally to pots and pans. More particularly, the present invention relates to pots and pans including dividers or separators.

### BACKGROUND OF THE INVENTION

Preparing a single meal for a family or group of individuals with dietary needs or specific preferences is challenging. Preparing a meal to be presented at the same time requires much coordination. There is an increasing number of people allergic to specific foods or spices. Some members of a group need to be sure not to eat certain foods for health reasons. Some need to eat balanced and nutritional meals while others can indulge with less healthy meals. The current practice includes the use of individual pots or pans to make each individual and separate meal to insure that the various meals provide the individual preferences and do not mix. This is impractical as most individuals are limited on cooking surfaces, pots and pans to prepare a meal at the same time.

There is a need for single pot or pan that provides separation of the foods and fluids cooking therein. There is a need for a single pot that can be used as a single pot or as a divided pot with multiple compartments. There is also a need for a single pot that provides versatility to cut down on the number of pots required to cook a plurality of different meals at once.

### SUMMARY OF THE INVENTION

The present invention provides for a pot or pan having an divider system with an internal separator or divider wall which is removably attached. This important feature will allow for the simultaneous cooking of the meal with each person of the group or family having his or her main course cooked to their individual taste and, yet, all meals for all members of the group or family will have their meals cooked at the same time, for unified and pleasant eating.

The present invention provides a cooking container having a dividing system including a pot or pan having a side wall and a bottom wall attached to the side wall, the side wall having at least one side connection member, the bottom wall having at least one bottom connection member; and at least one removably attached dividing wall for dividing the pot into distinct cooking sections, the at least one removably attached dividing wall extending into the side channel and the bottom channel.

The present invention further includes a cooking container wherein the at least one side connection member is at least one concaved side channel therein and the at least one bottom connection member is at least one concaved bottom channel therein.

The present invention further includes a cooking container wherein the at least one side connection member is at least one convex protrusion extending from the side wall and the at least one bottom connection member is at least one convex protrusion extending from said bottom wall, and the divider includes a corresponding concave portion matable with the at least one convex protrusions of said side wall and the bottom wall.

Additionally, the at least one side channel and the at least one bottom channel includes a sealant therein to prevent fluid communication between the distinct cooking sections. Additionally, the pot further includes a cover, wherein the cover is provided with one or more top hinges which allow for each of the distinct cooking sections to be exposed separately while keeping the balance of the pot or pan covered. Further, the pot includes a plurality of removable strainers wherein each of the plurality of strainers is shaped to fit within each of the distinct cooking sections to allow each section to be strained separately from each other. Furthermore, the at least one removably attached dividing wall includes a center connection portion and connectable dividing walls removably attached thereto.

### BRIEF DESCRIPTION OF DRAWINGS

FIG. 1 is a perspective view of a pan with one removable dividing wall, a separator, causing the internal surface of the pan to be divided into two cooking compartments;

FIG. 2 is a top view of the pan with the single removable dividing wall, a separator, showing the two cooking compartments.

FIG. 3 is a top view of the pan showing the bottom and side channels of the present invention.

FIG. 4 is a partial side cross sectional view of a bottom channel of the pan including sealing element therein.

FIG. 5 is a partial side cross sectional view of a bottom channel of the pan including sealing element and the divider therein.

FIGS. 6-8 are perspective views of various shaped pots and pans including a divider system of the present invention.

FIGS. 8-10 are perspective views of a cylindrical pan/pot having the divider system of the present invention and further including a split lid.

FIG. 11 is a perspective view of a pot of the present invention including strainers therein.

FIG. 12 is a perspective view of a pot of the present invention including a connector piece therein.

FIG. 13 is a perspective view of the connector piece of the present invention.

FIG. 14 is a top view of a pot with the divider system including various channels therein.

FIG. 15 is a perspective view of a pot of the present invention including strainers therein.

FIG. 16 is a perspective view of a pot of the present invention without a divider.

FIG. 17 is a top view of a pot with a divider therein.

### DETAILED DESCRIPTION OF THE PREFERRED EMBODIMENT

As seen in the Figures, a set of cookware (pots and pans) is provided with removable internal dividers or separators sealably connected thereto. The cookware is preferably made from metal, likely metallic bottoms and more preferably the bottom is copper for even and quick heating. However, it is contemplated that the cookware may be make from a polymer such as a thermoplastic which is food grade and able to withstand elevated cooking temperatures.

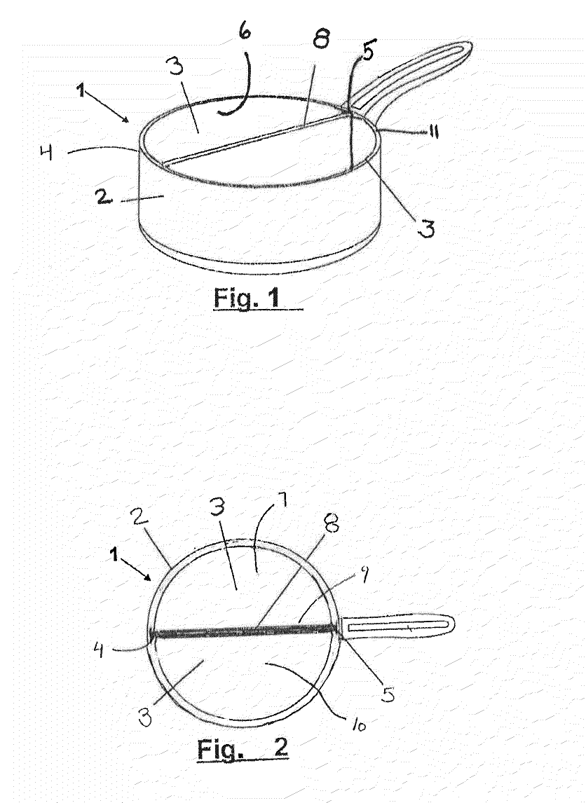

FIGS. 1 and 2 show pot 1 comprising a cylindrical side wall 2 and a bottom wall 7. The side wall 2 includes an interior side wall surface 6. The interior of the pot 1 is divided into a pair of distinct and separate compartments 3 and 4. The side wall 2 includes a pair of opposing side connection members 4, 5, show as vertical channels, extending into the side wall surface 6 for engagement and mating with a divider or separator 8. The pair of opposing side connection members 4, 5 extends vertically along and into the thickness of the side wall 2 of the pot 1 and a bottom channel 9 extends horizontally along and into the bottom surface 10 of the pot 1. The bottom channel 9 extends between the pair of opposing side connection members 4, 5 to provide a single continuous channel from one side of a top edge 11 of the pot to the other side of the top edge 11. The divider or separator element 8 extends from the inside, of the bottom channel 8 within the upper surface of the bottom of the pot or pan 1 vertically upwardly engaging in the connector members 9, 4, 5. Preferably, as seen in the drawings, the dividing wall or separator 8 extends to the top edge of the pot or pan. The divider wall or separator 8 extends generally across the diameter or radius of the interior of the pot or pan and the divider wall or separator 8, forming, with the inside of the side wall of the pot, the two smaller compartments 3, extends along a radius of the inside cylindrical wall of the pot. The divider or separator 8 extends into the channel and sealably seats within the channels to allow the pot to be divided into the two compartments 3. A locking mechanism can be provided to lock the divider within the channel. The locking mechanism can be a mechanical mechanism, such as a hinge or lever, or the locking mechanism can be provided by the sealant located within the connector members or channels.

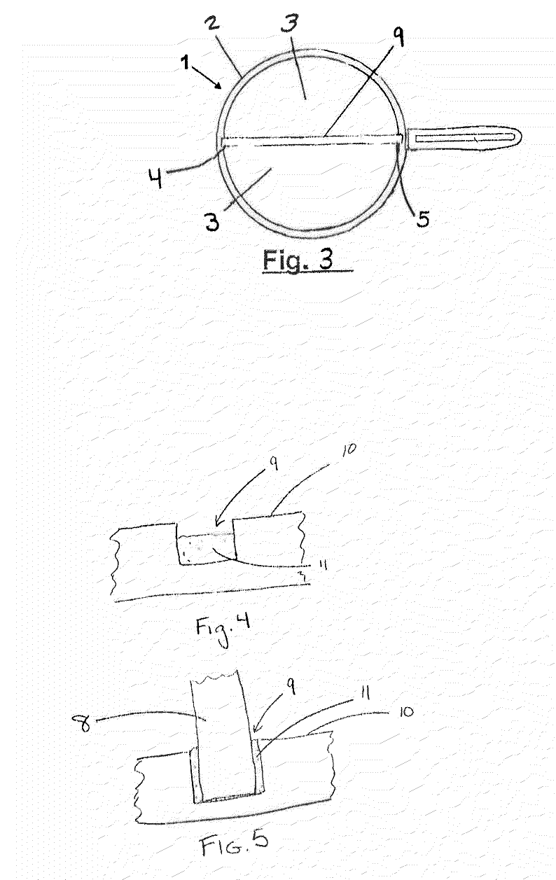

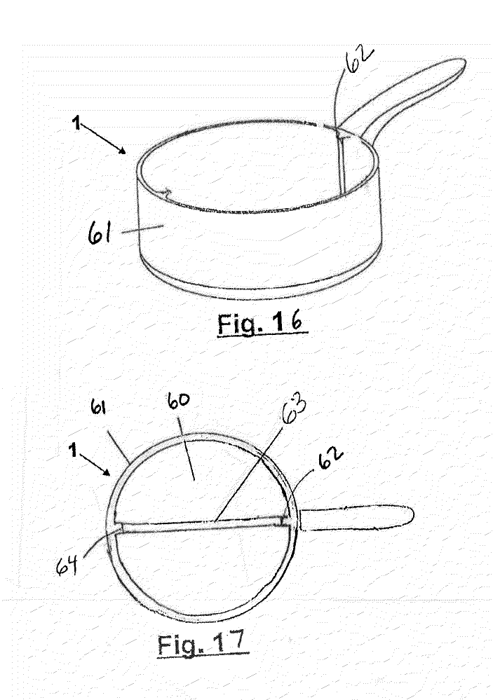

FIG. 3 shows pot 1 without the divider or separator 8. The connector members 4, 5 and 9 are concaved grooved etched into the material of the sidewall 2 and bottom surface 10, respectively. The connector members can be a variety of geometric shapes including a male connector or female connector that mate with the corresponding engagement edge of the divider. The channels are generally U-shaped and a seal element 11 therein. FIG. 16-17 show the reverse attachment between the divider and the side and bottom walls can be used in various types of pots and pans. FIG. 16 shows pot 1 without the divider but with the protrusions extending from the surfaces. FIG. 17 shows the pot 1 with the divider and the channels of the divider mating with the protrusions of the side/bottom wall. Specifically, the side and bottom wall surfaces 60, 61 include a protrusion or convex extension 62, 63 of the side wall and bottom wall protruding perpendicular to the surfaces and the divider(s) edges include a channel or concaved portion 64 which mates with the protrusions to prevent fluid communication between the compartments. The attachment points, i.e. channels or protrusions, of the interior surface of the pot and the attachment points, i.e. channels or protrusions, of the edges of the dividers can be any geometric shape that are combinable, attachable and mateable to form a fluid seal therebetween. Further, the seal element is located with the concaved connection portion of the divider edge or side/bottom walls.

FIG. 4 shows a partial view of bottom connector member 9 with the seal element 11 therein. The seal element 11 can be removable and/or replaceable. The seal element 11 is a biocompatible material that withstands high temperatures for direct heat without deteriorating or degrading. Preferably, the seal element can withstand temperatures greater than the boiling point of water, i.e., 212° F., preferably greater than 300° F., and more preferably greater than 350° F. In addition, the seal element 11 doesn't deteriorate with constant heating and cooling effects, and cleaning conditions that a pot 1 typically endures. The seal element 11 is able to be in direct contact with food without being harmful to the food, or cooking process. The seal element 11 is pliable and provides a seal about the divider edge to prevent the transfer of fluids across the dividers, and between the compartments. The seal element 11 is preferable an elastomer. The seal element 11 can be in the form of a bead, a strip, a gasket, piping, foam, plasma, rubber within the channel. The seal can completely fill the channel or partially fill within the channel.

FIG. 5 shows the bottom connector members 9 including the seal element 11 and a divider 8 engaged therein. The seal element 11 provides engagement of the divider to the pot and structural strength to the divider within the pot, while the seal element provides a seal about the channel and divider edges to prevent fluid exchange therebetween. FIG. 5 shows the seal element 11 moldable about the divider.

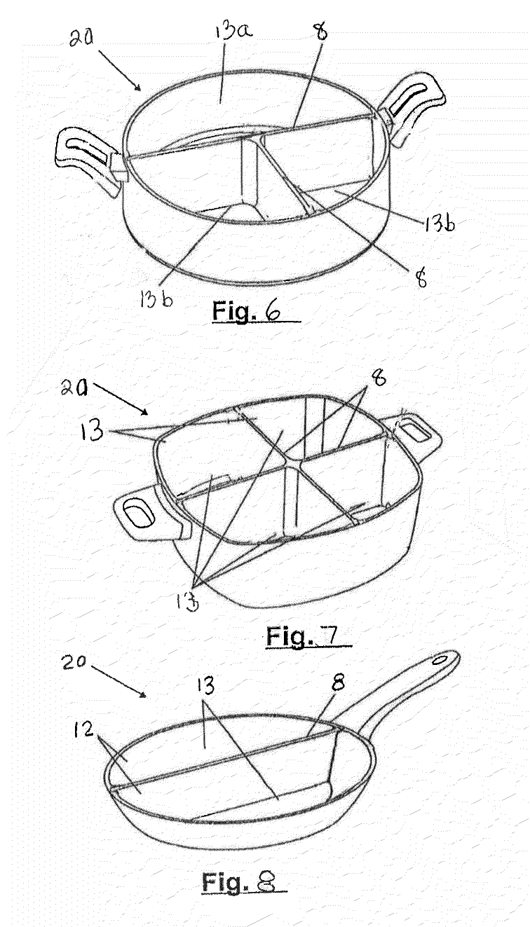

According to the embodiment and configuration shown in general in FIG. 6, a pot 20 has a single side wall. A separator 8 in a T-shape bisecting the interior of the pot and the other part perpendicular thereto divides the interior of the pot 2 into three compartments, a first large compartment 8a and a pair of substantially equal, quarter of the interior compartments, 8b and 8b. A pair of handles is provided to opposed ends of the pan to facilitate movement of the pot, as desired. This pot could be used, for example, to cook three or less separate dishes by removing the entire divider or portions of the divider if the divider formed from interconnectable

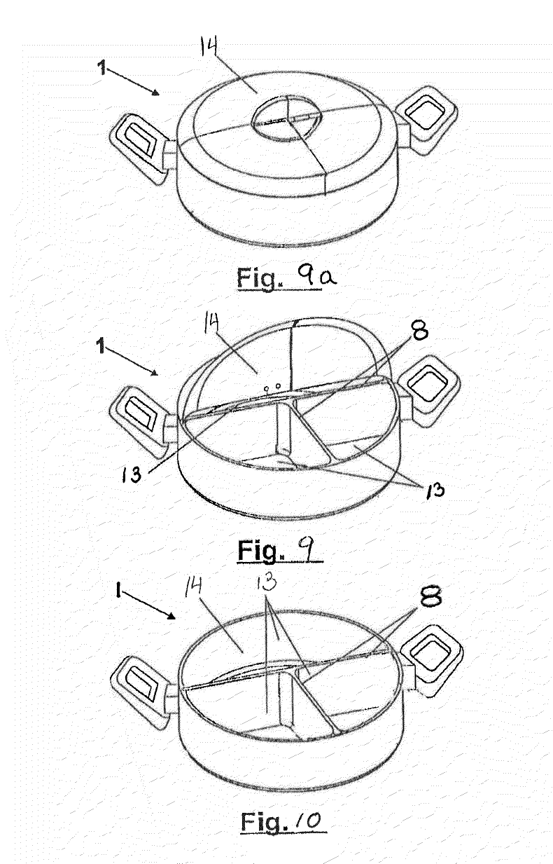

As shown in FIGS. 6-8, the divider system of the present invention including removable dividers 8, channels within the interior surfaces 12 and the seal element 11 can be incorporated into a variety of pots/pans 20 shapes as well as offer a plurality of compartments 13. FIG. 6 shows a divider 8 having a T-shape which provides three compartments. FIG. 7 shows a divider 8 having a cross shape providing four compartments. FIG. 8 shows a divider 8 having a planar shape bisecting the pan providing two compartments. The pot or pan is provided with a single flat surface which will rest upon the stove top and be heated by its heating element, whether accomplished by electric or gas. Thus, the pot/pan will provide an even and hot cooking surface to all compartments, at the same time, all controlled by the heating element of the cook or stove top. The present invention, however, allows for the economical use of a single heating element, a single pot/pan to make various individually seasoned meals or entrees at the same time and to make one or more entrees with one or more side dishes, also at the same time and by use of a common heating element. This, too, is economical in terms of use of pots/pans, in cleaning pots and pans after the meal, and in using the heating energy of the heating element for many food preparation steps at the same time. Cleaning of the pot is simplified because the divider is removable to allow for easy cleaning of the interior of the pot and the divider separately. The present invention provides for the economical use of gas or electric, a reduction in the number of pots/pans needed for food preparation for a small family; and saves, too, in the clean up of dirty pots and pans. Also, by having a multi-compartment pot/pan, storage space is conserved. Also, special dietary restrictions and meals salted or seasoned to individual taste can be provided by use of the compartmentalized pot and pan, comprising, in general, a single integrated bottom cooking surface and a dividing wall which separates the interior cooking surface into two or more separate compartments.

The present invention provides pots and pans with separate compartments for food preparation, each pot or pan having one or more removable dividing walls or separators. Preferably, the dividing walls are removably attached to the pot and pan by use of a concave channel element in which the divider or separator extending into and/or mates therewith. The channel allows the dividing wall to removably attach to the inside circumferential wall of the pan, allows for the cook, using standard cooking utensils to easily scrape the insider corners in order to ensure that no food sticks into the corners. The divider is removable which allows for ease of cleaning and allows for the divided pot to be used as a single compartment pot. Pots/pans having the versatility of removable sealable divider system of the present invention allows for a single pot to serve a variety of functions and flexibility.

The choice of the pot or pan needed for preparation of a meal is made at the beginning and the number of compartments determined to be equal to the number of food portions or individuals to be served or fed at the meal. Also, if the number of needed compartments is less than the number of available compartments of the divided pots and pans, then dividers are removable.

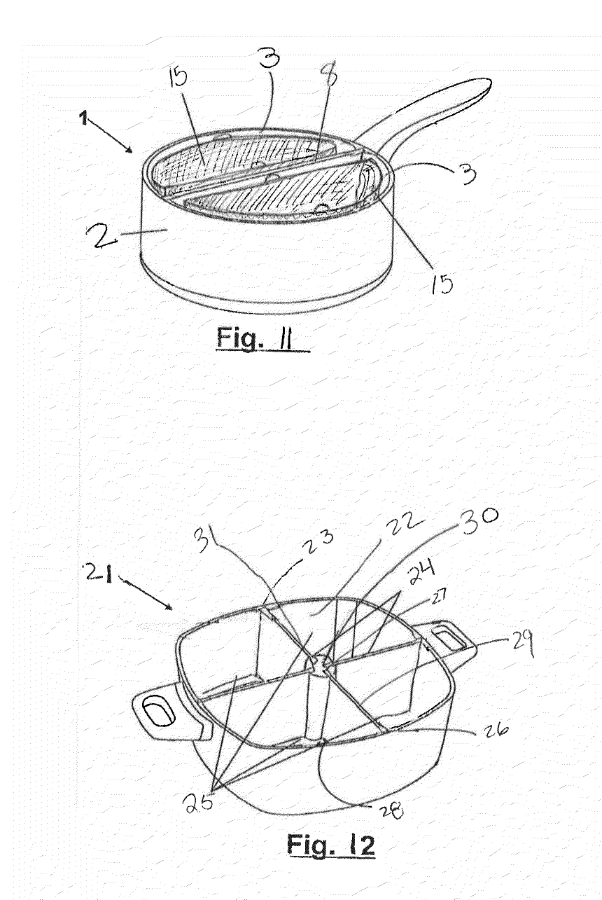

FIGS. 8-10 show a pot 1 of the present invention further including a split lid 14 which can be fully removed for exposing all compartments; can be flipped about a single large hinge to expose an entire ½ of the cooking area, i.e., a semi-circular section or, alternatively, can open about a smaller hinge to expose just one or the other ¼ of the cooking area, smaller sections. The split lids 14 can be incorporated into any of the pots/pans having the removable divider system of the present invention.

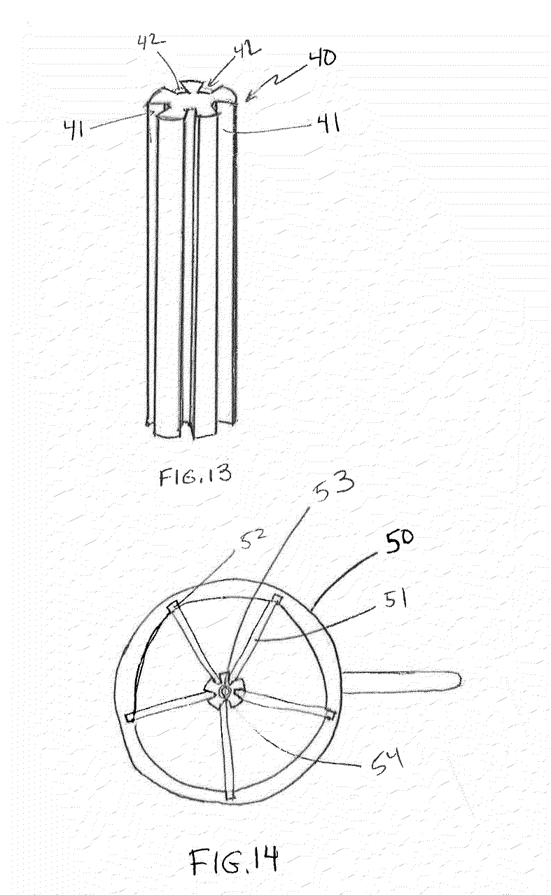

FIGS. 11 and 15 show the pot 1 of FIG. 1 including the sealably removable planar divider system and strainers 15 that are removable and designed to fit within each compartment. The strainers 15 can be sized to fit within any geometry of the compartments or any pot/pan designed with the divider system.

FIG. 12 shows a removable divider system of the present invention, similar to the pot of FIG. 7. The pot 21 includes the channels 23 on the sidewall 22 with a seal element therein. Dividers 24 provide compartments 25 in pot 21. The dividers 24 are planar, flat rectangular in-shape having two side edges 26, 27, a bottom edge 28 and an opposing top edge 29. Edge 26 slides into and mates with channel 23 in the sidewall 22 as above-described. Edge 28 slides into and mates with the bottom channel 9. The side edge 27 slides into a connector piece 30 which includes a plurality of channels 31 which are similar to the above-described channels including a seal element therein to seal the edge of the divider therein. The connector piece 30 can be a variety of shapes with a plurality of channels therein. The connector piece 30 is preferable removably attached to the pot 21 in a similar fashion as the dividers. The connector piece 30 includes a female or male connection piece at the end and mates with the opposing and matching male or female connector piece in the surface of the bottom side of the pot. The connector piece 30 is sealable mateable with the pot to prevent fluid exchange there beneath or about the sides. It is additionally contemplated that the connector piece 30 can be permanently formed from the bottom surface of the pot or welded thereto.

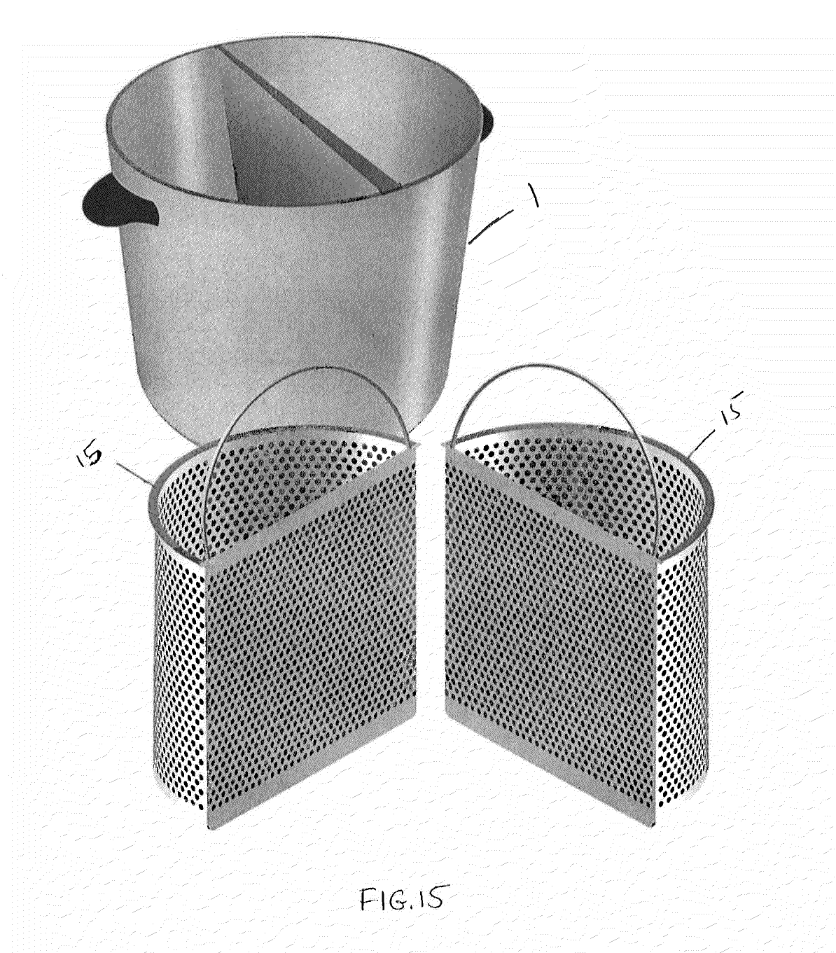

FIG. 13 shows the individual connector piece 40 including a plurality of channels 41 and a seal element 42 therein. The connector piece 40 is inserted into a pot having a mating channel in the center of the bottom surface with a similar shape as the cross section of connector piece 40 to allow for removable attachment thereto. FIG. 14 shows an inside of pot 50 with the bottom channels 51, side channels 52, and a mating channel 53 for attaching a connector piece 40. The mating channel 53 is preferably at a different depth from the bottom channels to provide for distinct sealing and attachment of the connector piece therein such that the connector piece remains in place when the dividers are removable attached and detached. Additionally, the connector piece 40 can include a threaded engagement member which can engaged with an interior threaded portion 54 in the pot.

Having described the preferred embodiments herein, it should now be appreciated that variations may be made thereto without departing from the contemplated scope of the invention. Accordingly, the preferred embodiments described herein are deemed illustrative rather than limiting, the true scope of the invention being set forth in the claims appended hereto.

What is claimed is:

1. A cooking container having a dividing system comprising:
a pot or pan having a side wall and a bottom wall attached to said side wall, said side wall having at least one side connection member, said bottom wall having at least one bottom connection member; and
at least one removably attached dividing wall for dividing said pot into distinct cooking sections, said at least one removably attached dividing wall extending into and matable with said side connection member and said bottom connection member.

2. A cooking container as claimed in claim 1 wherein said at least one side connection member is at least one concaved side channel therein and said at least one bottom connection member is at least one concaved bottom channel therein.

3. A cooking container as claimed in claim 1 wherein said at least one side connection member is at least one convex protrusion extending from said side wall and said at least one bottom connection member is at least one convex protrusion extending from said bottom wall, and said divider includes a corresponding concave portion matable with said at least one convex protrusions of said side wall and said bottom wall.

4. A cooking container as claimed in claim 1 wherein said at least one side channel and said at least one bottom channel include a sealant therein to prevent fluid communication between said distinct cooking sections.

5. A cooking container as claimed in claim 4 further comprising a cover wherein said cover is provided with one or more top hinges which allow for each of said distinct cooking sections to be exposed separately while keeping the balance of the pot or pan covered.

6. A cooking container as claimed in claim 4 further comprising a plurality of removable strainers wherein each of said plurality of strainers is shaped to fit within each of said distinct cooking sections to allow each section to be strained separately from each other.

7. A cooking container as claimed in claim 4 wherein at least one removably attached dividing wall includes a center connection portion and connectable dividing walls removably attached thereto.

8. A cooking container as claimed in claim 4 wherein said wherein at least one removably attached dividing wall includes two dividing walls.

9. A cooking container as claimed in claim 4 wherein said wherein at east one removably attached dividing wall has a T-shaped geometry.

10. A cooking container as claimed in claim 4 wherein said wherein at least one removably attached dividing wall has a cross-shaped geometry dividing an interior of said pot into four separate and distinct compartments.
